(19) United States
(12) Patent Application Publication
(10) Pub. No.: US 2021/0379616 A1
(43) Pub. Date: Dec. 9, 2021

(54) PIGGABLE PROPORTIONER AND PUMP

(71) Applicant: Graco Minnesota Inc., Minneapolis, MN (US)

(72) Inventors: Christopher J. Van Keulen, St. Michael, MN (US); Dennis J. Van Keulen, Rogers, MN (US); Vannareth J. Chum, Farmington, MN (US)

(21) Appl. No.: 17/285,994

(22) PCT Filed: Dec. 13, 2019
(86) PCT No.: PCT/US2019/066320

§ 371 Date: Apr. 16, 2021

Related U.S. Application Data
(60) Provisional application No. 62/780,304, filed on Dec. 16, 2018.

(51) Int. Cl. B05B 15/55; B05B 9/04; B05B 12/14

(52) U.S. Cl. CPC B05B 15/55; B05B 12/1481; B05B 9/0413

(57) ABSTRACT

A pump assembly for serial connection along a primary fluid line includes a pump and a pump bypass. The pump has an inlet side and an outlet side, and is configured to receive a first fluid from the inlet side, and expel the first fluid from the outlet side. The pump bypass is actuatable between first and second valve states. The first valve state fluidly connects the pump in series along the primary fluid line, and connects an input side of the primary fluid line to an output side of the primary fluid line only via the pump. The second valve state fluidly isolates the pump from the primary fluid line, and fluidly connects the input and output sides of the primary fluid line via a continuously piggable path.

### CROSS-REFERENCE TO RELATED APPLICATION

This Application claims priority to U.S. Provisional Application No. 62/780,304, filed Dec. 16, 2018, entitled “Piggable Proportioner and or Pump,” which is herein incorporated by reference in its entirety.

### BACKGROUND

The present invention relates generally to pump systems, and more particularly to piggable bypass that permits efficient flushing and cleaning of both a pump and the fluid line in which the pump is situated.

Fluid proportioners and other pumping systems are situated along fluid lines to drive fluid at a desired flow rate or pressure. Many fluid handling applications (e.g. for paint) require regularly switching pumped fluids, necessitating that the fluid line and pumping system be cleaned as completely as possible to prevent intermingling (i.e. contamination) of fluids. Even in pumping systems expected to only handle a single fluid type, regular cleaning can be required. Fluid residue can be removed by flushing a system with air, solvent, and/or other fluids. More viscous materials can require mechanical removal, i.e. by running a pig along or through the fluid line. The presence of a pump along a fluid line, however, poses a cleaning challenge. In fluid handling systems where a pig is expected to be necessary, pumps are accordingly only installed at ends of fluid lines, to minimize the extent of the fluid line inaccessible to the pig. In convention systems, this consideration limits where and what kinds of pumps can be used in piggable systems, and can result in significant quantities of pumped material being wasted during fluid changeovers.

### SUMMARY

In one aspect, the present disclosure is directed to a pump assembly for serial connection along a primary fluid line. This pump assembly includes a pump and a pump bypass. The pump has an inlet side and an outlet side, and is configured to receive a first fluid from the inlet side, and expel the first fluid from the outlet side. The pump bypass is actuatable between first and second valve states. The first valve state fluidly connects the pump in series along the primary fluid line, and connects an input side of the primary fluid line to an output side of the primary fluid line only via the pump. The second valve state fluidly isolates the pump from the primary fluid line, and fluidly connects the input and output sides of the primary fluid line via a continuously piggable path.

In another aspect, the present disclosure is directed to a piggable bypass configured for connection to a pump and a primary fluid line. This piggable bypass includes a fluid inlet, a fluid outlet, and a piggable passage extending between the fluid inlet and the fluid outlet. The fluid inlet is disposed to fluidly connect with an input section of the primary fluid line, while the fluid outlet is disposed to fluidly connect with an output section of the primary fluid line. The piggable bypass also includes an bypass valve, a pump input connection from the piggable passage to the pump, and a pump output connection from the pump to the piggable passage. The bypass valve is disposed along the piggable passage, between the fluid outlet and the fluid inlet. The pump input connection is situated between the fluid inlet and the bypass valve and fluidly sealable by a pump input valve, and the pump output connection is situated between the bypass valve and the fluid outlet and fluidly sealable by a pump outlet valve.

In still another aspect, the present disclosure is directed to a method of flushing a pump connected to a primary fluid line. According to this method, the pump is bypassed via a valved bypass, such that the pump and the primary fluid line are fluidly isolated and parallel. The pump is flushed while disconnected from the fluid line, and the fluid line is pigged through the valved bypass while disconnected from the pump. The pump is then reconnected with the primary fluid line via the valved bypass, such that the pump is fluidly connected in series along the primary fluid line.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a perspective view of a pump with a piggable bypass.

FIG. 2 is a first sectional view of the pump and piggable bypass of FIG. 1.

FIG. 3 is a second sectional view of the pump and piggable bypass of FIGS. 1 and 2.

FIG. 4 is a schematic view of a pumping system including the pump and piggable bypass of FIGS. 1-3.

While the above-identified figures set forth one or more embodiments of the present disclosure, other embodiments are also contemplated, as noted in the accompanying discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

This disclosure concerns a fluid handling system including a pump (such as a proportioning pump), a primary fluid line, and a piggable bypass disposed between the pump and primary fluid line. In a pumping state, the bypass connects pump in series along the fluidly, permitting fluid flow from an inlet side to an outlet side of the primary fluid line only through the pump. In a bypass state, the bypass directly fluidly connects the inlet side to the outlet side of the primary fluid line, bypassing and isolating the pump. The primary fluid line and the bypass have common geometry (e.g. width, shape) selected to permit a cleaning pig to be passed through the primary fluid line and the piggable bypass, without interruption, while the system is in the bypass state. The bypass also includes fluid inlets (e.g. for air, solvent, etc.) and outlets (for waste) that allow the pump to be flushed while it is isolated from the primary fluid line.

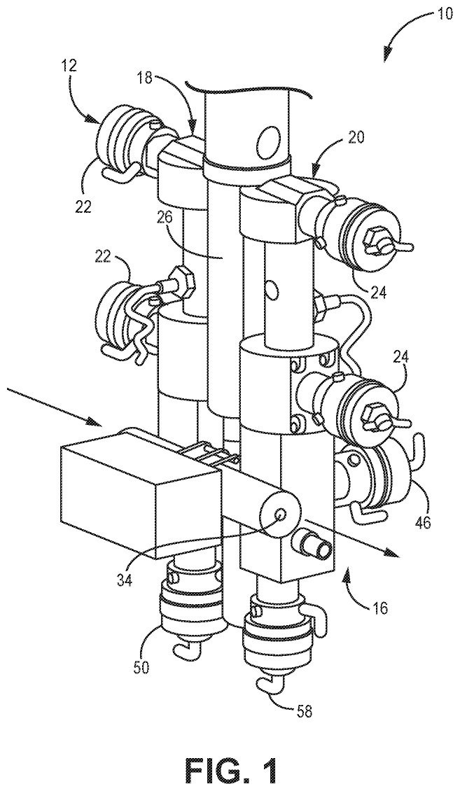

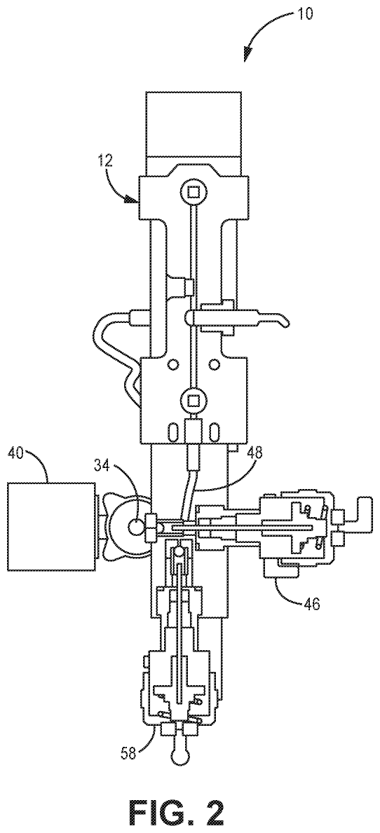

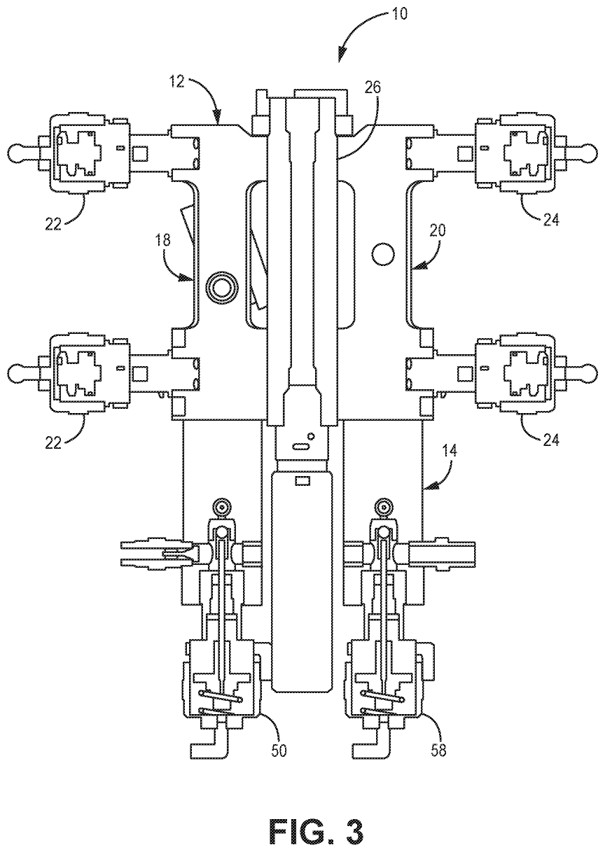

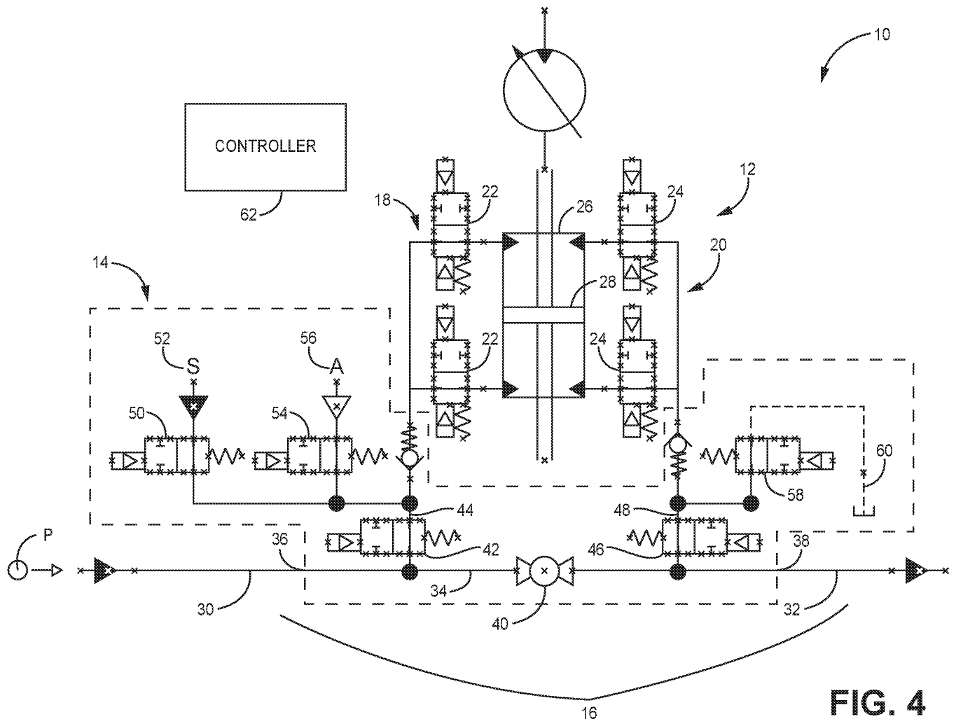

FIGS. 1-4 illustrate pumping system 10, with pump 12 and bypass assembly 14 situated along primary fluid line 16. FIG. 1 provides a perspective view of pumping system 10, FIGS. 2 and 3 provide orthogonal cross-sectional views, and FIG. 4 provides a schematic view. Pumping system 10 is system or part of a system for dispensing at least one fluid. Pumping system 10 can, for example, be a part of a paint or other sprayable material proportioning system.

Pump 12 can most generally be any fluid pump with input side 18 and output side 20. Pump 12 is illustrated as a reciprocating pump with input side 18 and output side 20, and with two input valves 22, two output valves 24, a cylinder 26, and a reciprocating plunger 28. More generally, however, a person skilled in the art will understand that other pump types can be used in pumping system 10 without departing from the scope or spirit of the present invention. Pump 12 drives fluid from input side 18 to output side 20, and can in some embodiments be a proportioning pump whereby the volume of fluid displaced by pump 12 is metered.

Bypass assembly 14 is a valved manifold actuatable between at least two valve states, as described in greater detail below. Bypass assembly 14 can be formed integrally with pump 12, or can be a separate component (e.g. a modular add-on) attached and fluidly sealed to pump 12. Pump 12 and bypass assembly 14 together form a pumping assembly. Primary fluid line 16 is a fluid conduit disposed to carry a fluid to and from pump 12 for pumping thereby. Primary fluid line 16 includes input section 30 upstream of pump 12, and output section 32 downstream of pump 12. Bypass assembly 14 forms the sole fluid communication path between primary fluid line 16 and pump 12, and is situated at least in part between input and output sections 18 and 20, respectively, of primary fluid line 16.

Bypass assembly 14 includes piggable passage 34 extending from fluid inlet 36 to fluid outlet 38. Although piggable passage 34 is considered a portion of bypass assembly 14 rather than primary fluid line 16 for the purpose of this discussion, various embodiments of system 10 can incorporate the structure of piggable passage 34 in either bypass assembly 14 of primary fluid line 16. More generally, piggable passage 34 fluidly connects to input side 30 at fluid inlet 36, and to output side 32 at fluid outlet 38, such that 30, 32 and 34 together form a continuously piggable line. Fluid inlet 36 attaches to and receives fluid from input section 30 of primary fluid line 16, for pumping by pump 12. Fluid outlet 38 attaches to and provides fluid to output section 32 of primary fluid line 16. In the illustrated embodiment, piggable passage 34 is a straight conduit directly from fluid inlet 36 to fluid outlet 38, interrupted only by bypass valve 40. In its closed state, bypass valve 40 fluidly separates input and output sections of piggable passage 34, such that fluid can flow from fluid inlet 36 to fluid outlet 38 only through pump 12. In its open state, bypass valve 40 allows passage directly between fluid inlet 36 and fluid outlet 38. In this open state, as discussed in greater detail hereinafter, piggable passage 34 can be traversed by a pig (i.e. for cleaning) together with both input and output sections of primary fluid line 16. Primary fluid line 16 (including both input side 30 and output side 32) and piggable passage 34 share a common cross-sectional geometry enabling a single pig (P; see FIG. 4) to be run along a continuously piggable path through both. Piggable passage 34 and primary fluid line 16 can, for example, have substantially circular cross-sections of equal diameter. More generally, piggable passage 34 and primary fluid line 16 can have any shape and passage width in common such that the pig can fit snugly and run through the fluid line and piggable passage without interruption while bypass valve 40 is open.

Bypass assembly 14 also includes pump inlet valve 42 disposed along pump inlet connection 44 between piggable passage 34 and input side 18 of pump 12, and pump outlet valve 46 disposed along pump outlet connection 38 between piggable passage 34 and output side 20 of pump 12. In the illustrated embodiment, pump inlet and outlet valves 42, 46 are both tap valves. Pump inlet and outlet valves 42, 46 serve as isolation valves, separating pump 12 and the majority of bypass assembly 14 from the piggable line including primary fluid line 16 and piggable passage 34. When closed, pump inlet and outlet valves 42, 46 separate pump 12 from piggable passage 34, and thereby from primary fluid line. When pump inlet and outlet valves 42, 46 are open and bypass valve 40 is closed, fluid from input side 18 of primary fluid line 16 can flow through fluid inlet 36 and pump inlet connection 44 into input side 18 of pump 12, through cylinder 26, and out from output side 20 of pump 12 through pump outlet connection 48 and fluid outlet 38 into output side 20 of primary fluid line 16.

Bypass assembly 14 also includes fluid lines and valves for cleaning bypass assembly 14 and pump 12 by flushing the pump assembly with cleaning fluid. Bypass assembly 14 can, for example, include cleaning inlet valve 50 connected to cleaning source 52, a supply or reservoir of cleaning fluid. Some embodiments of bypass assembly 14 can also include one or more additional cleaning valves 54 connected to further cleaning sources 56 In at least some embodiments, bypass assembly 14 can include cleaning source 52 for solvent and cleaning source 56 for air, with cleaning inlet valve 50 including a solvent fluid tap valve, and cleaning inlet valve 54 including an air chop valve. Cleaning source 52 (and 56, where present) connect with input side 18 of pump 12 when their respective cleaning inlet valves 50, 54 are open. Air, solvent, and/or other fluids are used to flush pump 12, and are then expelled from the pump assembly out of output side 20 of pump 12, through cleaning outlet valve 58 into cleaning exit 60, which serves as a waste dump. Cleaning exit 60 can, for example, vent into a waste disposal catch. FIGS. 1-3 illustrate embodiments lacking a second cleaning source and inlet valve (i.e. 54/56), while FIG. 4 illustrates an embodiment with two cleaning sources and inlet valves.

In the illustrated embodiment pumping system 10 includes controller 62, which can command actuation of the various valves of bypass assembly 14, including valves 40, 42, 46, 50, 54, and 58. Controller 62 can be a separate controller dedicated to the operation of bypass assembly 14 for cycling fluids and cleaning (by flushing pump 12, etc.), or can be a controller shared in common across other functions of pumping system 10 not discussed in detail herein, e.g. the control of pump 12 itself and its proportioning operation to supply working fluid at a metered rate. Controller 62 can be a processor of a generic computer loaded with appropriate task-specific software, or can be a dedicated processor solely for pumping system 10.

Controller 62 is responsible for commanding actuation of valves within pumping system 10 between a plurality of valve states including a primary pumping state and a cleaning state. In the primary pumping state, bypass valve 40 is closed, pump inlet valve 42 and outlet valve 46 are open, and cleaning valves 50, 54, and 58 are closed. In the cleaning state, bypass valve 40 is open, pump inlet valve 42 and outlet valve 46 are closed, and cleaning valves 50, 54, and 58 are at least intermittently open, e.g. to supply pulses of air and/or solvent for flushing pump 12. More generally, the cleaning state can be broken down into two separable substates: a pig line cleaning substate, and a pump cleaning substate. In the pig line cleaning substate bypass valve 40 is open and pump inlet valve 42 and outlet valve 46 are closed, permitting primary fluid line 16 and piggable passage 34 to be cleaned separately from pump 12, e.g. by running a pig continuously through both input and output sides of primary fluid line 16 by way of piggable passage 34, and/or by flushing the fluid line. In the pump cleaning substate pump inlet valve 42 and outlet valve 46 are closed, cleaning inlet valves 50 and 54 are at least intermittently open to supply a continuous or pulsed stream of cleaning material , and cleaning outlet 58 is open to vent waste. The pig line cleaning substate and pump cleaning substate can be combined into a single cleaning state, or can be performed separately (i.e. for cleaning either the primary fluid line or the pump without affecting the other). Controller 62 can also effect a fill state that differs from the primary pumping state only in that cleaning outlet valve is open to allow expulsion of waste material and/or air as pump 12 is filled.

During ordinary operation, valves are actuated to the fill state while a primary fluid is loaded into pump 12. During sustained proportioning, valves are actuated to the primary pumping state. Before changing primary fluids (e.g. swapping paints in a paint spraying system), valves are first actuated to the cleaning state or a substate thereof. Primary fluid line 16 and piggable passage 34 can be cleaned of the first primary fluid while the system is in the pig line cleaning substate, e.g. through use of a pig, while pump 12 and the remainder of bypass assembly 14 can be cleaned of the first primary fluid while the system is in the pump cleaning substate by flushing solvent and/or air through the manifold. These substate steps can be performed separately or simultaneously. A new primary fluid can then be loaded with the system in the fill state, and subsequently pumped with the system in the primary pumping state.

The pumping system and associated method set forth above permit the isolation of pump 12 from primary fluid line 16 via bypass assembly 14. This allows pump 12 and primary fluid line 16 to be independently cleaned. Additionally, this arrangement permits primary fluid line 16 to be pigged in its entirety, even when pump 12 is disposed at a mid-region of primary fluid line 16 (i.e. as distinct from at one or the other end of primary fluid line 16). This arrangement reduces fluid waste when the system is purged of primary fluid, e.g. to switch primary fluids, and permits the pump to be freely situated along primary fluid line 16 without introducing cleaning challenges. In some embodiments, the aforementioned architecture allows unused fluid from line 16 to be forced back to a fluid supply.

### Discussion of Possible Embodiments

The following are non-exclusive descriptions of possible embodiments of the present invention.

A pump assembly for serial connection along a primary fluid line, the pump assembly comprising: a pump having an inlet side and an outlet side, and configured to receive a first fluid from the inlet side, and expel the first fluid from the outlet side; and a pump bypass actuatable between first and second valve states: the first valve state fluidly connecting the pump in series along the primary fluid line, and connecting an input side of the primary fluid line to an output side of the primary fluid line only via the pump; and a second valve state fluidly isolating the pump from the primary fluid line, and fluidly connecting the input and output sides of the primary fluid line via a continuously piggable path.

The pump assembly of the preceding paragraph can optionally include, additionally and/or alternatively, any one or more of the following features, configurations and/or additional components:

A further embodiment of the foregoing pump assembly, wherein the pump bypass further comprises: a piggable passage extending from the input side of the primary fluid line to the output side of the primary fluid line, and interrupted only by an bypass valve; a pump inlet valve disposed fluidly between the piggable passage and the inlet side of the pump; and a pump outlet valve disposed fluidly between the piggable passage and the outlet side of the pump.

A further embodiment of the foregoing pump assembly, wherein the pump bypass further comprises: a first cleaning inlet fluidly connected to the inlet side of the pump via a first cleaning inlet valve, and fluidly separable from the piggable passage by the pump inlet valve; and a cleaning outlet fluidly connected to the outlet side of the pump via a cleaning outlet valve, and fluidly separable from the piggable passage by the pump outlet valve.

A further embodiment of the foregoing pump assembly,further comprising a controller configured to command actuation of the bypass valve, the pump inlet valve, the pump outlet valve, the first cleaning inlet valve, and the cleaning outlet valve, such that: in the first valve state: the bypass valve is closed; the pump inlet and pump outlet valves are open; and the first cleaning inlet and the cleaning outlet valves are closed; and in the second valve state: the bypass valve is open and the pump inlet and pump outlet valves are closed.

A further embodiment of the foregoing pump assembly, wherein the controller is further configured to cycle the pump so as to drive fluid from the input side to the output side of the primary fluid line in the first valve state, and so as to flush the pump with cleaning fluid in the second valve state.

A further embodiment of the foregoing pump assembly, wherein the pump is a proportioning pump, and wherein cycling the pump so as to drive fluid from the input side to the output side of the primary fluid line comprises driving fluid in proportioned quantities.

A further embodiment of the foregoing pump assembly, further comprising a second cleaning inlet parallel to the first cleaning outlet. The second cleaning inlet connected to the inlet side of the pump via a second cleaning inlet valve, and fluidly separable from the piggable passage by the pump inlet valve.

A further embodiment of the foregoing pump assembly, wherein the piggable passage shares a passage width and a passage shape with the primary fluid line, such that a pig can run snugly through the input side of the primary fluid line, the piggable passage, and the output side of the primary fluid line, without interruption, while the bypass valve is open.

A piggable bypass configured for connection to a pump and a primary fluid line, the piggable bypass comprising: a fluid inlet disposed to fluidly connect with an input section of the primary fluid line; a fluid outlet disposed to fluidly connect with an output section of the primary fluid line; a piggable passage extending between the fluid inlet and the fluid outlet; an bypass valve disposed along the piggable passage, between the fluid outlet and the fluid inlet; a pump input connection from the piggable passage to the pump, the pump input connection situated between the fluid inlet and the bypass valve and fluidly sealable by a pump input valve; and a pump output connection from the pump to the piggable passage, the pump output connection situated between the bypass valve and the fluid outlet and fluidly sealable by a pump outlet valve.

The piggable bypass of the preceding paragraph can optionally include, additionally and/or alternatively, any one or more of the following features, configurations and/or additional components:

A further embodiment of the foregoing piggable bypass, wherein the fluid inlet, the fluid outlet, and the bypass valve share a common geometry with the primary fluid line, permitting a pig to be passed snugly and without interruption through the fluid inlet, the fluid outlet, the bypass valve, the input section of the primary fluid line, and the output section of the primary fluid line.

A further embodiment of the foregoing piggable bypass, wherein the common geometry includes a common passage width and a common passage shape.

A further embodiment of the foregoing piggable bypass, wherein the common shape is a circular cross-section, and the common passage width is a common diameter.

A further embodiment of the foregoing piggable bypass, further comprising: a cleaning inlet fluidly connected to the pump inlet and fluidly sealable by a cleaning inlet valve; and a cleaning outlet fluidly connected to the pump outlet and fluidly sealable by a cleaning outlet valve.

A further embodiment of the foregoing piggable bypass, wherein the piggable bypass is actuatable between two valve states: a primary pumping valve state wherein the bypass valve is closed, the pump input and output valves are open, and the cleaning input and output valves are closed; and a cleaning valve state wherein the bypass valve is open, the pump input and output valves are closed, and the cleaning input and output valves are open.

A further embodiment of the foregoing piggable bypass, further comprising a controller disposed to command actuation between the primary pumping valve state and the cleaning valve state.

A method of flushing a pump connected to a primary fluid line, the method comprising: bypassing the pump via a valved bypass, such that the pump and the primary fluid line are fluidly isolated and parallel; flushing the pump while the pump is disconnected from the fluid line; pigging the fluid line through the valved bypass, while the fluid line is disconnected from the pump; and reconnecting the pump with the primary fluid line via the valved bypass, such that the pump is fluidly connected in series along the primary fluid line.

The method of the preceding paragraph can optionally include, additionally and/or alternatively, any one or more of the following features, configurations and/or additional components:

A further embodiment of the foregoing method, wherein flushing the pump comprises introducing cleaning fluid into the pump, cycling the pump, and draining the pump of the cleaning fluid.

A further embodiment of the foregoing method, wherein the steps of bypassing the pump and reconnecting the pump comprise actuations of valves within the valved bypass.

A further embodiment of the foregoing method, wherein the valved bypass is capable of operating in at least two valve states: a first valve state used when the pump is reconnected, and wherein a first side of the primary fluid line is connected to a second side of the primary fluid line only through the pump; and a second valve state used when the pump is bypassed, and wherein the first and second sides of the primary fluid line are connected through the bypass and fluidly isolated from the pump.

A method of changing fluids in the pump of the foregoing method, the method comprising: pumping a first fluid through the pump while the valved bypass is in the first valve state; performing the foregoing method; and pumping a second fluid different from the first fluid through the pump while the valved bypass is in the first valve state.

Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A pump assembly for serial connection along a primary fluid line, the pump assembly comprising:
a pump having an inlet side and an outlet side, and configured to receive a first fluid from the inlet side, and expel the first fluid from the outlet side; and
a pump bypass actuatable between first and second valve states:
the first valve state fluidly connecting the pump in series along the primary fluid line, and connecting an input side of the primary fluid line to an output side of the primary fluid line only via the pump; and
a second valve state fluidly isolating the pump from the primary fluid line, and fluidly connecting the input and output sides of the primary fluid line via a continuously piggable path.

2. The pump assembly of claim 1, wherein the pump bypass further comprises:
a piggable passage extending from the input side of the primary fluid line to the output side of the primary fluid line, and interrupted only by a bypass valve;
a pump inlet valve disposed fluidly between the piggable passage and the inlet side of the pump; and
a pump outlet valve disposed fluidly between the piggable passage and the outlet side of the pump.

3. The pump assembly of claim 2, wherein the pump bypass further comprises:
a first cleaning inlet fluidly connected to the inlet side of the pump via a first cleaning inlet valve, and fluidly separable from the piggable passage by the pump inlet valve; and
a cleaning outlet fluidly connected to the outlet side of the pump via a cleaning outlet valve, and fluidly separable from the piggable passage by the pump outlet valve.

4. The pump assembly of claim 3, further comprising a controller configured to command actuation of the bypass valve, the pump inlet valve, the pump outlet valve, the first cleaning inlet valve, and the cleaning outlet valve, such that:
in the first valve state: the bypass valve is closed; the pump inlet and pump outlet valves are open; and the first cleaning inlet and the cleaning outlet valves are closed; and
in the second valve state: the bypass valve is open and the pump inlet and pump outlet valves are closed.

5. The pump assembly of claim 4, wherein the controller is further configured to cycle the pump so as to drive fluid from the input side to the output side of the primary fluid line in the first valve state, and so as to flush the pump with cleaning fluid in the second valve state.

6. The pump assembly of claim 5, wherein the pump is a proportioning pump, and wherein cycling the pump so as to drive fluid from the input side to the output side of the primary fluid line comprises driving fluid in proportioned quantities.

7. The pump assembly of claim 3, further comprising a second cleaning inlet parallel to the first cleaning outlet. The second cleaning inlet connected to the inlet side of the pump via a second cleaning inlet valve, and fluidly separable from the piggable passage by the pump inlet valve.

8. The pump assembly of claim 2, wherein the piggable passage shares a passage width and a passage shape with the primary fluid line, such that a pig can run snugly through the input side of the primary fluid line, the piggable passage, and the output side of the primary fluid line, without interruption, while the bypass valve is open.

9. A piggable bypass configured for connection to a pump and a primary fluid line, the piggable bypass comprising:
a fluid inlet disposed to fluidly connect with an input section of the primary fluid line;
a fluid outlet disposed to fluidly connect with an output section of the primary fluid line;
a piggable passage extending between the fluid inlet and the fluid outlet;
an bypass valve disposed along the piggable passage, between the fluid outlet and the fluid inlet;
a pump input connection from the piggable passage to the pump, the pump input connection situated between the fluid inlet and the bypass valve and fluidly sealable by a pump input valve; and
a pump output connection from the pump to the piggable passage, the pump output connection situated between the bypass valve and the fluid outlet and fluidly sealable by a pump outlet valve.

10. The piggable bypass of claim 9, wherein the fluid inlet, the fluid outlet, and the bypass valve share a common geometry with the primary fluid line, permitting a pig to be passed snugly and without interruption through the fluid inlet, the fluid outlet, the bypass valve, the input section of the primary fluid line, and the output section of the primary fluid line.

11. The pump bypass of claim 10, wherein the common geometry includes a common passage width and a common passage shape.

12. The pump bypass of claim 11, wherein the common shape is a circular cross-section, and the common passage width is a common diameter.

13. The pump bypass of claim 9, further comprising:
a cleaning inlet fluidly connected to the pump inlet and fluidly sealable by a cleaning inlet valve; and
a cleaning outlet fluidly connected to the pump outlet and fluidly sealable by a cleaning outlet valve.

14. The pump bypass of claim 13, wherein the piggable bypass is actuatable between two valve states:
a primary pumping valve state wherein the bypass valve is closed, the pump input and output valves are open, and the cleaning input and output valves are closed; and
a cleaning valve state wherein the bypass valve is open, the pump input and output valves are closed, and the cleaning input and output valves are open.

15. The pump bypass of claim 14, further comprising a controller disposed to command actuation between the primary pumping valve state and the cleaning valve state.

16. A method of flushing a pump connected to a primary fluid line, the method comprising:
bypassing the pump via a valved bypass, such that the pump and the primary fluid line are fluidly isolated and parallel;
flushing the pump while the pump is disconnected from the fluid line;
pigging the fluid line through the valved bypass, while the fluid line is disconnected from the pump; and
reconnecting the pump with the primary fluid line via the valved bypass, such that the pump is fluidly connected in series along the primary fluid line.

17. The method of claim 16, wherein flushing the pump comprises introducing cleaning fluid into the pump, cycling the pump, and draining the pump of the cleaning fluid.

18. The method of claim 16, wherein the steps of bypassing the pump and reconnecting the pump comprise actuations of valves within the valved bypass.

19. The method of claim 18, wherein the valved bypass is capable of operating in at least two valve states:
a first valve state used when the pump is reconnected, and wherein a first side of the primary fluid line is connected to a second side of the primary fluid line only through the pump; and
a second valve state used when the pump is bypassed, and wherein the first and second sides of the primary fluid line are connected through the bypass and fluidly isolated from the pump.

20. A method of changing fluids in the pump of the method of claim 18, the method of changing fluids comprising:
pumping a first fluid through the pump while the valved bypass is in the first valve state;
performing the method of claim 18; and
pumping a second fluid different from the first fluid through the pump while the valved bypass is in the first valve state.
